(19) United States
(12) Patent Application Publication
(10) Pub. No.: US 2013/0260189 A1
(43) Pub. Date: Oct. 3, 2013

(54) GRAPHENE IN LITHIUM ION BATTERIES

(71) Applicant: Li-Tec Battery GmbH, Kamenz (DE)

(72) Inventor: Tim Schaefer, Niedersachswerfen (DE)

(21) Appl. No.: 13/799,238

(22) Filed: Mar. 13, 2013

Related U.S. Application Data
(60) Provisional application No. 61/611,615, filed on Mar. 16, 2012.

(30) Foreign Application Priority Data
Mar. 16, 2012 (DE) 10 2012 005 426.2

(51) Int. Cl. H01M 4/36

(52) U.S. Cl. CPC H01M 4/366
USPC 429/50; 429/246; 429/231.95; 429/224; 429/221; 429/223; 429/231.5; 429/231.8; 429/144; 427/122

(57) ABSTRACT

A lithium ion battery comprising at least two electrodes, each comprising at least one metallic substrate and one material able to intercalate metallic lithium or lithium ions or which can conduct lithium ions and with which the metallic substrate can be coated, wherein the metallic substrate and the material each form a boundary layer between them; one separator which separates the electrodes from one another and with which the material of the electrodes is coated, wherein the material and the separator form respective boundary layers between them, characterized in that a layer of material comprising or consisting of graphene extends at least partially into at least one of said boundary layers.

The present invention relates to a lithium ion battery comprising graphene.

US 2011/0111302 A1 proposes an electrode for a lithium ion battery having a high storage capacity and a long operating life. Nanoparticles or thin layers which contain the electrode's active material are thereby sandwiched between graphene layers or the graphene layers are coated with the nanoparticles or the thin layers respectively, whereby the active material and the graphene layers are embedded into a graphite network.

Rechargeable lithium ion batteries for use in vehicles with hybrid or wholly electric drive or as a stationary storage system need to meet high requirements in terms of their safety, operating life and available electrical output.

The object of the present invention is to provide an electrochemical cell, preferably a rechargeable lithium ion battery, which improves on at least one of the cited requirements.

This object is accomplished by employing graphene in an electrochemical cell, preferably a rechargeable lithium ion battery, as defined in claim 1. Advantageous further developments are defined in the subclaims.

Accordingly, the invention relates to an electrochemical cell, preferably a rechargeable lithium ion battery, comprising at least:
(i) one first electrode comprising at least one first metallic substrate and one first active material able to intercalate metallic lithium or lithium ions or which can conduct lithium ions and with which the first metallic substrate is coated, wherein the first metallic substrate and the first active material form a first boundary layer between them;
(ii) one second electrode comprising at least one second metallic substrate and one second active material able to intercalate metallic lithium or lithium ions or which can conduct lithium ions and with which the second metallic substrate is coated, wherein the second metallic substrate and the second active material form a second boundary layer between them;
(iii) one separator which separates the first electrode and the second electrode from one another and which coats the first active material and the second active material, wherein the first active material and the separator form a third boundary layer between them, and the second active material and the separator form a fourth boundary layer between them, characterized in that a layer of a third material comprising graphene is at least partially provided in at least one of said boundary layers.

In one embodiment, the third material is substantially composed of graphene.

The inventors of the present invention discovered that material which comprises graphene or which is composed of graphene and which extends as a layer at least partially into at least one of the aforesaid defined boundary layers in an electrochemical cell, preferably a lithium ion battery, can improve the mechanical properties of the battery. In particular, the additional use of graphene layers can mitigate the volumetric change in the active materials utilized in the electrodes which can lead to mechanical stress as frequently observed during charging/discharging.

It was furthermore found that an outgassing of volatile components from the battery such as, for example, fluorinated compounds or other volatile elements contained in electrolytes when the battery is damaged, is hindered or even inhibited when the electrodes and/or the separator are coated with graphene or material containing graphene.

It was additionally found that the use of graphene can increase the battery's operating life as well as decrease its internal resistance, which in turn leads to improving its electrical efficiency.

### Embodiments of an Inventive lithium ion Battery

In one embodiment of the inventive lithium ion battery, a layer of a third material which comprises graphene or which is graphene extends at least partially into the first boundary layer.

In a further embodiment, a layer of a third material which comprises graphene or which is graphene extends at least partially into the second boundary layer.

In a further embodiment, a layer of a third material which comprises graphene or which is graphene extends at least partially into the third boundary layer.

In a further embodiment, a layer of a third material which comprises graphene or which is graphene extends at least partially into the fourth boundary layer.

In a further embodiment, a layer of a third material which comprises graphene or which is graphene extends in each case at least partially into the first and second boundary layer.

In a further embodiment, a layer of a third material which comprises graphene or which is graphene extends in each case at least partially into the first and third boundary layer.

In a further embodiment, a layer of a third material which comprises graphene or which is graphene extends in each case at least partially into the first and fourth boundary layer.

In a further embodiment, a layer of a third material which comprises graphene or which is graphene extends in each case at least partially into the first, second and third boundary layer.

In a further embodiment, a layer of a third material which comprises graphene or which is graphene extends in each case at least partially into the first, second and fourth boundary layer.

In a further embodiment, a layer of a third material which comprises graphene or which is graphene extends in each case at least partially into the first, third and fourth boundary layer.

In a further embodiment, a layer of a third material which comprises graphene or which is graphene extends in each case at least partially into the first, second and third boundary layer.

In a further embodiment, a layer of a third material which comprises graphene or which is graphene extends in each case at least partially into the second and third boundary layer.

In a further embodiment, a layer of a third material which comprises graphene or which is graphene extends in each case at least partially into the second and fourth boundary layer.

In a further embodiment, a layer of a third material which comprises graphene or which is graphene extends in each case at least partially into the second, third and fourth boundary layer.

In a further embodiment, a layer of a third material which comprises graphene or which is graphene extends in each case at least partially into the third and fourth boundary layer.

The terms used in the following are terms as defined within the meaning of the present disclosure.

The term “boundary layer” refers to the layer formed between two distinguishable areas, particularly surfaces, when said areas are in contact with and/or overlap one another.

In one embodiment, a surface of the first metallic substrate thus forms a boundary layer with the surface of a first active material which can intercalate metallic lithium or lithium ions or which can conduct lithium ions upon the surfaces contacting and/or overlapping.

In a further embodiment, a surface of the second metallic substrate forms a boundary layer with the surface of a second active material which can intercalate metallic lithium or lithium ions or which can conduct lithium ions upon the surfaces contacting and/or overlapping.

In a further embodiment, a surface of the separator forms a boundary layer with the surface of the first or second active material which can intercalate metallic lithium or lithium ions or which can conduct lithium ions upon the surfaces contacting and/or overlapping.

In one embodiment, the first metallic substrate, the first active material, the second metallic substrate, the second active material as well as the separator are all films.

In one embodiment, the first metallic substrate, the first active material, the second metallic substrate, the second active material as well as the separator form a laminate.

In a further embodiment, the first metallic substrate, the first active material, the second metallic substrate, the second active material as well as the separator form a laminate of films.

The term “graphene” refers to a modification of carbon in a two-dimensional structure in which each carbon atom is surrounded by three other carbon atoms so as to form a honeycomb pattern.

Graphene can contain—contingent upon the production process such as e.g. the reduction of graphite oxide—further atoms and/or groups other than carbon. Graphene as used within the meaning of the present invention can therefore also contain oxygen, for example in the form of hydroxyl or carboxyl groups, as well as nitrogen or sulfur, alkali metal cations, or mixtures thereof.

In one embodiment, it is also possible for the graphene to comprise further substances as found in graphene as nanoparticles or nanoparticles at least partially coating the graphene. Suitable nanoparticles are preferably nano-particles made of or comprising silicon. Nanoparticles made of tin or tin alloys or nanoparticles comprising tin or tin alloys can also be used.

Graphene can be a film, preferably a film in the form of flakes, or a nanotube.

Suitable methods of producing graphene are known from the prior art.

In one embodiment, the term “third material comprising graphene” means that the third material consists of graphene.

Battery

The terms “lithium ion battery,” “rechargeable lithium ion battery” and “lithium ion secondary battery” are used synonymously. The terms also encompass the terms “lithium battery,” “lithium ion accumulator” and “lithium ion cell.”Thus, the term “lithium ion battery” is used as the collective term for the aforementioned terms commonly used in the prior art. It refers to both rechargeable batteries (secondary batteries) as well as non-rechargeable batteries (primary batteries). In particular, a “battery” within the meaning of the present invention also encompasses an individual or single “electrochemical cell.”A “battery”preferably comprises two or more such electrochemical cells connected together, either in series (i.e. consecutively) or parallel.

Electrodes

The inventive electrochemical cell, preferably a lithium ion battery, comprises at least two electrodes; i.e. a first and a second electrode.

The first electrode can thereby be the positive electrode, whereby the second electrode is then the negative electrode, or vice versa.

Both of the electrodes thereby each comprise a material which can conduct lithium ions or intercalate lithium ions or metallic lithium; i.e. a first or a second active material. Within the meaning of the present invention, said first and second material are also interchangeably identified as the first active material and the second active material.

The term “positive electrode” refers to the electrode which is able to absorb electrons when the battery is connected to an electrical load such as an electric motor, for example. It constitutes the cathode in the present nomenclature.

The term “negative electrode” refers to the electrode which is able to discharge electrons during operation. It constitutes the anode in the present nomenclature.

The electrodes preferably comprise inorganic material or inorganic substance compounds which can be used for or in or on an electrode or as an electrode. Based on its chemical properties, a lithium ion battery's operating conditions allow for these compounds or substances to preferably be able to conduct lithium ions, or absorb (intercalate) lithium ions or metallic lithium respectively, and also discharge them again. The prior art also refers to such material as the “active material” of the electrode. Said material is preferably deposited on a substrate for use within an electrochemical cell/battery, preferably a metallic substrate, preferably aluminum or copper.

The metallic substrate is also referred to as a “conductoror a “collector.”

Positive Electrode

All materials known from the relevant prior art can be used as the active material for the positive electrode. Thus, there are no limitations regarding the positive electrode as defined by the present invention.

In one embodiment, lithium phosphate can be used as the active material for the positive electrode, preferably of the empirical formula LiXPO₄ whereby X═Mn, Fe, Co or Ni, or combinations thereof.

Further applicable compounds include lithium manganate, preferably LiMn₂O₄, lithium cobaltate, preferably LiCoO₂, lithium nickelate, preferably LiNiO₂, or mixtures of two or more of these oxides or their mixed oxides.

In one embodiment, the positive electrode can exhibit an aluminum oxide coating. The active material, which is preferably a lithium/cobalt/nickel mixed oxide or a lithium/nickel/manganese mixed oxide, is then preferably coated with aluminum oxide.

Further compounds can be provided in the active material in order to increase conductivity, preferably compounds containing carbon or carbon preferably in the form of carbon black or graphite. The carbon can also be introduced in the form of carbon nanotubes. Such additives are preferably applied at an amount of 1-6 wt %, preferably 1-3 wt %, of the positive electrode mass deposited on the substrate.

The active material can also contain mixtures of two or more of the cited substances.

Negative Electrode

Suitable materials for the negative electrode are selected from among: lithium metal oxides such as lithium titanium oxide, materials containing carbon, preferably graphite, synthetic graphite, graphene, carbon black, mesocarbon, doped carbon and fullerene. Niobium pentoxide, tin alloys, titanium dioxide, tin dioxide and silicon are also preferred electrode materials for the negative electrode.

Binding Agent

The materials used for the positive or the negative electrode, for example the active materials, can be bound together by one or more binding agents which bond said materials to the electrode or to the conductor respectively. Styrene-butadiene rubber (SBR), polyvinylidene fluoride, polyethylene oxide, polyethylene, polypropylene, polytetrafluorethylene, polyacrylate, ethylene-propylene-diene monomer copolymer (EPDM) and mixtures and copolymers thereof are preferable as suitable binding agents.

In one embodiment, the first and/or the second metallic substrate is/are copper or aluminum; and the first active material is selected from among a first group comprising a lithium phosphate, preferably of the empirical formula LiXPO₄ whereby X═Mn, Fe, Co or Ni, or combinations thereof; or lithium manganate, preferably LiMn₂O₄, lithium cobaltate, preferably LiCoO₂, lithium nickelate, preferably LiNiO₂, or mixtures of two or more of these oxides or their mixed oxides; and the second active material is selected from among a second group comprising lithium metal oxides such as lithium titanium oxide, materials containing carbon, preferably graphite, synthetic graphite, carbon black, mesocarbon, doped carbon, fullerene, niobium pentoxide, tin alloys, titanium dioxide, tin dioxide and silicon.

In a further embodiment, the first active material is selected from the second group and the second active material is selected from the first group; i.e. the first and/or the second metallic substrate is/are copper or aluminum, and the second active material is selected from among a first group comprising a lithium phosphate, preferably of the empirical formula of LiXPO₄ whereby X⊚Mn, Fe, Co or Ni, or combinations thereof; or lithium manganate, preferably LiMn₂O₄, lithium cobaltate, preferably LiCoO₂, lithium nickelate, preferably LiNiO₂, or mixtures of two or more of these oxides or their mixed oxides; and the first active material is selected from among a second group comprising lithium metal oxides such as lithium titanium oxide, materials containing carbon, preferably graphite, synthetic graphite, carbon black, mesocarbon, doped carbon, fullerene, niobium pentoxide, tin alloys, titanium dioxide, tin dioxide and silicon.

Separator

Electrochemical cells, particularly rechargeable lithium ion batteries, comprise a material which separates the positive electrode from the negative electrode. Said material is permeable to lithium ions, thus conducts lithium ions, but is non-conductive to electrons. Such materials used in lithium ion batteries are also called separators.

In one embodiment, a ceramic separator can be used as the separator within the meaning of the invention.

In a preferred embodiment within the meaning of the invention, polymers are used as the separators. In one embodiment, the polymers are selected from among the group consisting of: polyester, preferably polyethylene terephthalate or polybutylene terephthalate; polyolefin, preferably polyethylene, polypropylene or polybutylene; polyacrylonitrile; polycarbonate; polysulfone; polyether sulfone; polyvinylidene fluoride; polystyrene; polyetherimide; polyether; polyether ketone.

The polymers can be used as film, preferably in the form of a membrane. The polymers exhibits pores so as to be permeable to lithium ions.

In a further embodiment, the polymers can be used in the form of fibers. The fibers can be woven or non-woven.

The use of glass fibers or cellulose fibers as a separator is likewise possible.

In one preferred embodiment within the meaning of the invention, the separator comprises at least one polymer and at least one ceramic material which coats the polymer.

Hence, the separator is also characterized by being provided as a polymer film, or as a polymer film coated with a ceramic material, or as woven or non-woven polymer fibers, or as woven or non-woven polymer fibers coated with a ceramic material.

In one preferred embodiment, the separator comprises at least one polymer and at least one inorganic, preferably ion-conducting material, preferably selected from among oxides, phosphates, silicates, titanates, sulfates and alumino-silicates exhibiting at least one of the elements of zircon, aluminum or lithium.

In one embodiment, said separator of the inventive battery exhibits polymer fibers in the form of a fibrous web. The fibrous web is preferably unwoven.

The term “non-woven”is also used in place of the term “unwoven.”The relevant technical literature also uses terms such as “non-woven fabrics” or “non-woven material.” The term “fibrous web” is used synonymously with the term “non-woven fabric.”

Fibrous webs are known from the prior art and/or can be manufactured pursuant known methods, for example spinning technologies with subsequent hardening.

The fibrous web is preferably flexible and produced at a thickness of less than 30 μm.

The polymer fibers are preferably selected from among the group of polymers consisting of polyester, polyolefin, polyamide, polyacrylonitrile, polyimide, polyetherimide, polysulfone, polyamide-imide, polyether, polyphenylene sulfide, aramide, or mixtures of two or more of these polymers.

Polyesters are e.g. polyethylene terephthalate and polybutylene terephthalate.

Polyolefins are e.g. polyethylene or polypropylene. Polyolefins which contain halogen such as polytetrafluorethylene, polyvinylidene fluoride and polyvinyl chloride can likewise be employed.

Polyamids are e.g. the types PA 6.6 and PA 6.0, known by their trademarks of Nylon® and Perlon®.

Aramids are e.g. meta-aramid and para-aramid, known by their trademarks of Nomex® and Kevlar®.

Polyamidimides are known for example by their trademark of Kermel®. Preferential polymer fibers are polymer fibers from polyethylene terephthalates.

In one preferred embodiment, the separator comprises a fibrous web which is coated with an inorganic material on one or both sides.

The term “coating” also encompasses the ion-conducting inorganic material not only being provided on one side or both sides of the fibrous web but also within the fibrous web.

The ion-conducting inorganic material used for the coating is preferably at least one compound from among the group of oxides, phosphates, sulfates, titanates, silicates and aluminosilicates comprising at least one of the elements of zircon, aluminum or lithium.

The ion-conducting inorganic material is preferably conductive to ions, particularly conductive to ions with regard to lithium ions, in a temperature range of from −40° C. to 200° C.

In one embodiment, a separator which consists of a substrate at least partially permeable to material can be used, same being not, or only poorly, conductive to ions. This substrate is coated on at least one side with an inorganic material. An organic material at least partially permeable to material which is formed as fibrous web; i.e. from non-woven polymer fibers, is used as the substrate. The organic material is in the form of polymer fibers, preferably polymer fibers of polyethylene terephthalate (PET). The fibrous web is coated with an inorganic ion-conducting material which preferably conducts ions in a temperature range of from −40° C. to 200° C. The inorganic ion-conducting material preferably comprises at least one compound from among the group of oxides, phosphates, sulfates, titanates, silicates, aluminosilicates having at least one of the elements of zircon, aluminum or lithium, with zirconium oxide being particularly preferential. The inorganic ion-conducting material preferably comprises particles having their largest diameter not exceeding 100 Nm.

In one preferred embodiment, the ion-conducting material comprises or consists of zirconium oxide.

An example of such a separator is marketed in Germany by the Evonik AG company under the trade name of “Separion®.”

Methods for producing such separators are known from the prior art, for example from EP 1 017 476 B1, WO 2004/021477 and WO 2004/021499.

In principle, when pores and cavities in separators used in secondary batteries are too large, this can lead to internal short circuits. The battery may then discharge very quickly in a dangerous reaction. This can result in electric currents which are so high that a closed battery cell can, in the most unfavorable case, even explode. For this reason, the separator (also) plays a crucial role in the safety and/or the lack thereof of a lithium high-performance or high-energy battery.

Polymer separators generally prevent any transport of charge as of a specific temperature (the so-called “shut-down temperature”), which is approx. 120° C. This ensues due to the fact that the separator's pore structure breaks down at this temperature and all the pores close. Since no more ions can then be transported, the result is the dangerous reaction which can lead to an explosion. If the cell continues to heat up due to external circumstances, however, the so-called “break-down temperature” is then exceeded at approx. 150-180° C. As of this temperature, the separator will melt, thereby contracting. This then results in the two electrodes being in direct contact at a number of points within the battery cell and thus to a large-area internal short circuit. This triggers the uncontrolled reaction which can end with the explosion of the cell or the developing pressure needing to be dissipated by means of a relief valve (a bursting disk), frequently accompanied by flame or sparks.

By having the separator preferably used in the inventive battery comprising a fibrous web of non-woven polymer fibers and the inorganic coating, shut-down can only occur when the polymer structure of the substrate material melts due to high temperature and penetrates into the pores of the inorganic material, thereby closing them. In contrast, break-down does not occur in the inventive separator since the inorganic particles ensure that the separator cannot fuse completely. Hence, maximum precaution is taken to exclude any operating states in which a large-area internal short circuit can occur.

Based on the type of fibrous web utilized, which exhibits a particularly well-suited combination of thickness and porosity, separators can be produced which are able to satisfy the requirements demanded of separators in high-performance batteries; lithium high-performance batteries in particular. Simultaneously using oxide particles precisely coordinated in particle size to produce the porous (ceramic) coating achieves a finished separator with particularly high porosity, whereby the pores are still small enough to prevent the unwanted growth of “lithium whiskers”through the separator.

Due to the separator's high porosity, however, care must be taken that no dead space forms in the pores or only the slightest amount possible.

The separator preferably used for the inventive battery also has the advantage that some of the anions of the conducting salt can deposit on the inorganic surfaces of the separator material, which leads to improved dissociation and thus to improved ionic conductivity in the high-current range.

The separator preferably used for the inventive battery, comprising a flexible fibrous web having a porous inorganic coating on and within said fibrous web, wherein the material of the fibrous web is selected from (preferably non-woven) polymer fibers, is also characterized by the fibrous web exhibiting a thickness of less than 30 μm, a porosity of more than 50%, preferably 50-97%, and a pore radius distribution at which at least 50% of the pores have a pore radius of 75-150 μm.

In one embodiment, the separator of fibrous web and ceramic coating has a porosity of 30-80%, preferably 40-75%, and particularly preferentially of 45-70%. Porosity thereby refers to the accessible; i.e. open, pores. The porosity can thereby be determined by means of the known mercury porosimetry method or can be calculated from the volume and the density of the materials used when the assumption can be made that there are only open pores.

In a further embodiment, the non-woven fibrous web has a porosity of 60-90%, particularly preferentially of 70-90%. Porosity is thereby defined as the volume of the fibrous web (100%) minus the volume of the fibers of the fibrous web, thus the percentage of the fibrous web volume not filled with material. The volume of the fibrous web can thereby be calculated from the dimensions of said fibrous web. The volume of the fibers yields from the measured weight of the respective fibrous web and the density of the polymer fibers. The high porosity of the substrate also enables a higher porosity for the separator, which is why the separator can absorb a greater amount of electrolyte.

It is particularly preferential for the separator to comprise a fibrous web having a thickness of from 5 to 30 μm, preferably a thickness of from 10 to 20 μm. The most homogenous possible pore radius distribution in the fibrous web as specified above is also particularly important. In conjunction with optimally coordinated oxide particles of specific size, an even more homogeneous pore radius distribution in the fibrous web leads to optimized porosity for the separator.

The thickness of the substrate can have a great influence on the separator's properties, since not only the flexibility but also the surface resistance of the separator saturated with electrolyte are dependent on the substrate's thickness. Low thickness results in a particularly low separator electrical resistance in application with an electrolyte. The separator itself exhibits a very high electrical resistance as it needs to exhibit self-insulating properties relative the electrons. In addition, thinner separators allow increased packing density within a battery stack so that a larger amount of energy can be stored in the same volume.

So as to obtain a separator having insulating properties, same preferably comprises non-electrically conductive polymer fibers as defined above as the polymer fibers for the non-woven fibrous web. Same is preferably selected from among the above-specified polymers, preferably polyacrylonitrile, polyester such as e.g. polyethylene terephthalate and/or polyolefin such as e.g. polypropylene or polyethylene or mixtures of such polyolefins.

The polymer fibers of the fibrous web preferably have a diameter of 0.1-10 μm; 1 to 4 μm is particularly preferential.

Particularly preferential flexible fibrous web has a surface weight of less than 20 g/m², preferably 5 to 10 g/m².

The separator in the preferably non-woven fibrous web preferably exhibits a porous, electrically insulating, ceramic coating. Preferably, the porous inorganic coating on and within the fibrous web comprises oxide particles of the elements Li, Al, Si and/or Zr having an average particle size of 0.5 to 7 μm, preferably 1 to 5 μm, and most particularly preferentially of from 1.5 to 3 μm. It is particularly preferential for the separator to have a porous inorganic coating on and within the fibrous web which comprises aluminum oxide particles of an average particle size of 0.5 to 7 μm, preferably 1 to 5 μm, and most particularly preferably of from 1.5 to 3 μm, bonded to an oxide of the elements Zr or Si. In order to obtain the highest porosity possible, more than 50 wt %, and particularly preferably more than 80 wt %, of all the particles are preferably within the above-cited average particle size limits. As described above, the maximum particle size preferably amounts to ⅓ to ⅕, and particularly preferably less than or equal to 1/10, of the thickness of the fibrous web employed.

The separators preferably used for the inventive battery are also characterized in that they can exhibit a tensile strength of at least 1 N/cm, preferably at least 3 N/cm, and particularly preferably of from 3 to 10 N/cm. The separators can preferably bend to each radius down to 100 mm, preferably down to 50 mm, and most particularly preferentially down to 1 mm without damage. This makes the separator also suitable for use in combination with coiled electrodes.

The separator's high tensile strength and flexibility also yields the advantage that the separator can experience the changes in electrode geometry which occur when the battery is being charged or discharged without being damaged. This is extremely advantageous in terms of the cell's stability and safety.

In one embodiment, it is preferential for the separator to be configured such that it exhibits the form of a concave or convex sponge or cushion or the form of filaments or felt. This embodiment is well-suited to equalizing volumetric changes in the battery. The appropriate manufacturing processes are known to the expert.

In a further embodiment, the polymer fibrous web used in the separator comprises a further polymer. This polymer is preferably disposed between the separator and the positive electrode and/or the separator and the negative electrode, preferably in the form of a polymer layer.

In one embodiment, one or both sides of the separator is coated with said polymer.

Said polymer can be in the form of a porous membrane; i.e. a film, or in the form of a fibrous web, preferably a fibrous web of non-woven polymer fibers.

The polymers are preferably selected from among the group consisting of polyester, polyolefin, polyacrylonitrile, polycarbonate, polysulfone, polyether sulfone, polyvinylidene fluoride, polystyrene and polyetherimide.

Preferably, the further polymer is a polyolefin. Preferred polyolefins are polyethylene and polypropylene.

The separator is preferably coated with one or more layers of the further polymer, preferably the polyolefin, which is preferably also a fibrous web; i.e. non-woven polymer fibers.

A fibrous web of polyethylene terephthalate is preferably used in the separator which is coated with one or more layers of the further polymer, preferably the polyolefin, which is preferably also a fibrous web; i.e. non-woven polymer fiber.

It is particularly preferential for the separator to be of the above-described Separion type which is coated with one or more layers of the further polymer, preferably the polyolefin, same preferably also being a fibrous web; i.e. non-woven polymer fiber.

Coating with the further polymers, preferably with the polyolefin, can be realized by bonding, laminating, by a chemical reaction, by heat-sealing or by establishing a mechanical connection. Such polymer composites as well as methods of producing them are known from EP 1 852 926.

The fibrous webs in the separator are preferably made from nanofibers of the polymers employed, whereby fibrous webs are formed which have a high porosity coupled with small pore diameters. This can thus further reduce the risk of short-circuit reactions.

The fiber diameters of the polyethylene terephthalate fibrous web are preferably larger than the fiber diameters of the further polymer fibrous web, preferably the polyolefin fibrous web, with which the separator is coated on one or both sides.

The fibrous web made from polyethylene terephthalate then preferably exhibits a greater pore diameter than the fibrous web made from the further polymers.

The use of a polyolefin additionally to the polyethylene terephthalate ensures increased safety for the electrochemical cell since the pores of the polyolefin contract and the transport of charge through the separator reduces and/or stops when the cell heats up undesirably or too high. If the temperature of the electro-chemical cell should increase to the point that the polyolefin begins to melt, the polyethylene terephthalate effectively counters the fusing of the separator and thus an uncontrolled destruction of the electrochemical cell.

Thus, the separator according to the invention can be a porous polymer film, a woven or non-woven fibrous web of polymer fibers, or a woven or non-woven fibrous web of polymer fibers coated on one or both sides with an inorganic material able to conduct lithium ions.

In one embodiment, the separator comprises the electrolytes used in the battery. The separator is then preferably saturated with the electrolytes.

In one embodiment, the electrolyte in the separator is a solid electrolyte.

Also preferential is an embodiment in which the separator forms a polymer electrolyte together with the lithium salt electrolyte.

Electrolyte

Elements of the electrolyte are at least an organic solvent and a lithium salt. The electrolyte can additionally contain further elements.

The term “electrolyte” or “lithium salt electrolyte” preferably signifies a liquid and a conducting salt. The liquid is preferably a solvent for the conducting salt. The electrolyte is then preferably an electrolytic solution. However, polymer electrolytes are also possible.

Suitable solvents are preferably inert. Suitable solvents are preferably solvents such as ethyl carbonate, propylene carbonate, butylene carbonate, dimethyl-carbonate, diethyl carbonate, ethyl methyl carbonate, methyl propyl carbonate, butyl methyl carbonate, ethyl propyl carbonate, dipropyl carbonate, cyclopentanone, sulfolane, dimethyl sufoxide, 3-methyl-1,3-oxazolidin-2-on, γ-butyrolactone, 1,2-diethoxymethane, tetrahydrofuran, 2-methyltetrahydrofuran, 1,3-dioxolane, methyl acetate, ethyl acetate, nitromethane and 1,3-propane sultone.

In one embodiment, ionic liquids can also be used as solvents. Such “ionic liquids”contain only ions. Preferred cations, which can in particular be alkylated, are imidazolium, pyridinium, pyrrolidinium, guanidinium, uronium, thiuronium, piperidinium, morpholinium, sulfonium, ammonium and phosphonium cations. Examples of suitable anions are halogenide, tetrafluoroborate, trifluoroacetate, triflate, hexafluorophosphate, phosphinate and tosylate anions.

Cited as exemplary ionic liquids are: N-methyl-N-propyl-piperidinium-bis(trifluoro-methylsulfonyl)imide, N-methyl-N-butyl-pyrrolidinium-bis(trifluoromethyl-sulfonyl)-imide, N-butyl-N-trimethyl-ammonium-bis(trifluoromethyl-sulfonyl)imide, triethyl-sulfonium-bis(trifluoromethylsulfonyl)imide and N,N-diethyl-N-methyl-N-(2-methoxyethyl)-ammonium-bis(trifluoromethylsulfonyl)-imide.

The employing of two or more of the liquids specified above is preferred.

Preferential conducting salts are lithium salts exhibiting inert anions and which are preferably non-toxic. Suitable lithium salts are preferably lithium hexafluorophosphate, lithium hexafluoroarsenate, lithium-bis(trifluoromethyl-sulfonylimide), lithium trifluoromethanesulfonate, lithium-tris(trifluoro-methylsulfonyl)-methide, lithium tetrafluoroborate, lithium perchlorate, lithium tetrachloroaluminate, lithium bis(oxalato)borate, lithium difluoro(oxalato)borate and/or lithium chloride; and mixtures of one or more of these salts.

In one embodiment, some or all of the organic solvent can be dispensed with. In this embodiment, the electrolyte can then be a solid mass or a mass having solid consistency.

In one embodiment, the electrolyte containing the comb polymer is a solid electrolyte or a polymer electrolyte.

The electrolyte can be produced by mixing the electrolyte components according to known methods.

Manufacturing the Inventive Battery

The battery can be manufactured analogously to the methods used in the prior art.

In one embodiment, the electrode material can be applied to a metallic substrate in the form of a paste, preferably by calendering or extruding. After the applied paste has dried, the active material is then in the form of a coating on the metallic substrate.

According to the invention, prior to the active material being applied to the metallic substrate, a material which comprises or consists of graphene can be deposited on said substrate. Said material is preferably applied to the substrate as a paste. Applying a material which comprises or consists of graphene in the form of a suspension or solution is likewise possible. For example, the graphene can be in the paste or the suspension in the form of flakes or tubes. After the evaporation of the volatile components, the material remaining on the substrate contains or consists of graphene. Coating with the active material can follow thereafter such that a layer of material containing or consisting of graphene extends at least partially into the boundary layer formed by the substrate and the active material. As a result, the active material is deposited on the material containing graphene or the layer formed of graphene, preferably in the above described manner.

Either one or both sides of the separator used in the battery can be analogously at least partially coated with a material containing or consisting of graphene. It is hereby conceivable for the coating to be precipitated from the liquid or the gaseous phase.

After the separator is saturated with electrolyte, the battery can be produced by joining the electrodes and the separator together, whereby the latter separates the electrodes from each other; i.e. is positioned between the electrodes.

Accordingly, the invention also relates to a method for manufacturing an inventive lithium ion battery which comprises at least one or more of the following steps (i) to (vi):
(i) at least partially coating a first metallic substrate with a third material comprising graphene; and subsequently coating the third material with a first active material which intercalates metallic lithium or lithium ions or which can conduct lithium ions such that a layer of the third material extends at least partially into the boundary layer formed between the first metallic substrate and the first active material;
(ii) at least partially coating a second metallic substrate with a third material comprising graphene; and subsequently coating the third material with a second active material which intercalates metallic lithium or lithium ions or which can conduct lithium ions such that a layer of the third material extends at least partially into the boundary layer formed between the second metallic substrate and the second active material;
(iii) at least partially coating a first metallic substrate with a first active material which intercalates metallic lithium or lithium ions or which can conduct lithium ions; and subsequently coating the first active material with a third material comprising graphene; and subsequently coating the third material with a separator such that a layer of the third material extends at least partially into the boundary layer formed between the first active material and the separator;
(iv) at least partially coating a second metallic substrate with a second active material which intercalates metallic lithium or lithium ions or which can conduct lithium ions; and subsequently coating the second active material with a third material comprising graphene; and subsequently coating the third material with a separator such that a layer of the third material extends at least partially into the boundary layer formed between the second active material and the separator;
(v) at least partially coating a separator with a third active material comprising graphene; and subsequently coating with a first metallic substrate which is coated with a first active material which intercalates metallic lithium or lithium ions or which can conduct lithium ions such that a layer of the third material extends at least partially into the boundary layer formed between the separator and the first active material;
(vi) at least partially coating a separator with a third active material comprising graphene; and subsequently coating with a second metallic substrate which is coated with a second active material which intercalates metallic lithium or lithium ions or which can conduct lithium ions such that a layer of the third material extends at least partially into the boundary layer formed between the separator and the second active material.

Using the Inventive Battery

The inventive electrochemical cell, preferably in the form of a lithium ion battery, can be used to supply energy to portable information devices, tools, electrically powered automobiles, hybrid-drive automobiles and stationary energy stores.

The lithium battery according to the invention can preferably be operated at ambient temperatures of from −40 to +100° C.

The discharge currents of a battery according to the invention are preferably greater than 100 A, preferentially greater than 200 A, preferentially greater than 300 Å, and further preferentially greater than 400 Å.

Using Graphene in a Lithium Ion Battery

A further object of the invention relates to the use of a material comprising or consisting of graphene in a lithium ion battery.

In one embodiment, the invention relates to the use of a material comprising or consisting of graphene to coat a conductor for a positive and/or negative electrode of an electrochemical cell, preferably a lithium ion battery; a positive and/or negative electrode and/or a separator of an electrochemical cell, preferably a lithium ion battery.

A further object of the invention relates to the use of a material comprising or consisting of graphene in an electrochemical cell, preferably a lithium ion battery, as a gas barrier for volatile components.

The term “volatile components” denotes all substances found within an electro-chemical cell able to be converted into the gaseous state. Solvents used in or as the electrolyte are preferably volatile components. They can preferably be thermally volatilized. The term “volatile components” furthermore also encompasses all volatile substances which can form from decomposition reactions. Such decomposition reactions are for example the hydrolysis of conducting salts containing fluorine to form volatile hydrogen fluoride.

In one embodiment, the material comprising or consisting of graphene is used as a gas barrier for hydrogen fluoride or 1,3-propanesultone vapor.

1-14. (canceled)

15. A lithium ion battery comprising:
(i) a first electrode comprising at least one first metallic substrate and one first active material able to intercalate metallic lithium or lithium ions or which can conduct lithium ions and with which the first metallic substrate is coated, wherein the first metallic substrate and the first active material form a first boundary layer between them;
(ii) a second electrode comprising at least one second metallic substrate and one second active material able to intercalate metallic lithium or lithium ions or which can conduct lithium ions and with which the second metallic substrate is coated, wherein the second metallic substrate and the second active material form a second boundary layer between them; and
(iii) a separator which separates the first electrode and the second electrode from one another and which coats the first active material and the second active material, wherein the first active material and the separator form a third boundary layer between them, and the second active material and the separator form a fourth boundary layer between them,
wherein a layer of a third material comprising grapheme extends at least partially into at least one of said boundary layers.

16. The lithium ion battery according to claim 15, wherein a layer of a third material comprising graphene extends at least partially into the first boundary layer.

17. The lithium ion battery according to claim 15, wherein a layer of a third material comprising graphene extends at least partially into the second boundary layer.

18. The lithium ion battery according to claim 15, wherein a layer of a third material comprising graphene is at least partially provided in the third boundary layer.

19. The lithium ion battery according to claim 15, wherein a layer of a third material comprising graphene is at least partially provided in the fourth boundary layer.

20. The lithium ion battery according to claim 15, wherein the third material consists of graphene.

21. The lithium ion battery according to claim 15, wherein the graphene is in the form of a film or the form of nanotubes.

22. The lithium ion battery according to claim 15, wherein at least one of the first and/or the second metallic substrate is/are copper or aluminum; and the first active material is selected from among a first group consisting of a lithium phosphate, preferably of the empirical formula LiXPO4 whereby X═Mn, Fe, Co or Ni, or combinations thereof; or lithium manganate, preferably LiMn2O4, lithium cobaltate, preferably LiCoO2, lithium nickelate, preferably LiNiO2, or mixtures of two or more of these oxides or their mixed oxides; and the second active material is selected from among a second group consisting of lithium metal oxides such as lithium titanium oxide, materials containing carbon, preferably graphite, synthetic graphite, carbon black, mesocarbon, doped carbon, fullerenes, niobium pentoxide, tin alloys, titanium dioxide, tin dioxide and silcone; or wherein the first active material is selected from the second group and the second active material is selected from the first group.

23. The lithium ion battery according to claim 15, wherein the separator is a porous polymer film, a woven or non-woven fibrous web of polymer fibers, or a woven or non-woven fibrous web of polymer fibers coated on one or both sides with an inorganic material able to conduct lithium ions.

24. A method of manufacturing the lithium ion battery according to claim 15, comprising at least one or more of the following steps (i) to (vi):
(i) at least partially coating a first metallic substrate with a third material comprising graphene; and subsequently coating the third material with a first active material which intercalates metallic lithium or lithium ions or which can conduct lithium ions such that a layer of the third material extends at least partially into the boundary layer formed between the first metallic substrate and the first active material;
(ii) at least partially coating a second metallic substrate with a third material comprising graphene; and subsequently coating the third material with a second active material which intercalates metallic lithium or lithium ions or which can conduct lithium ions such that a layer of the third material extends at least partially into the boundary layer formed between the second metallic substrate and the second active material;
(iii) at least partially coating a first metallic substrate with a first active material which intercalates metallic lithium or lithium ions or which can conduct lithium ions; and subsequently coating the first active material with a third material comprising graphene; and subsequently coating the third material with a separator such that a layer of the third material extends at least partially into the boundary layer formed between the first active material and the separator;
(iv) at least partially coating a second metallic substrate with a second active material which intercalates metallic lithium or lithium ions or which can conduct lithium ions; and subsequently coating the second active material with a third material comprising graphene; and subsequently coating the third material with a separator such that a layer of the third material extends at least partially into the boundary layer formed between the second active material and the separator;
(v) at least partially coating a separator with a third active material comprising graphene; and subsequently coating with a first metallic substrate which is coated with a first active material which intercalates metallic lithium or lithium ions or which can conduct lithium ions such that a layer of the third material extends at least partially into the boundary layer formed between the separator and the first active material; and
(vi) at least partially coating a separator with a third active material comprising graphene; and subsequently coating with a second metallic substrate which is coated with a second active material which intercalates metallic lithium or lithium ions or which can conduct lithium ions such that a layer of the third material extends at least partially into the boundary layer formed between the separator and the second active material.

25. A method comprising:
using the lithium ion battery according to claim 15 to supply energy to portable information devices, tools, electrically powered automobiles, hybrid-drive automobiles and/or stationary energy stores.

26. A method comprising:
using a material comprising graphene to coat one or more of (a) a conductor for a positive electrode of a lithium ion battery, (b) a conductor for a negative electrode of a lithium ion battery, (c) a positive electrode of a lithium ion battery, (d) a negative electrode of a lithium ion battery, and (e) a separator of a lithium ion battery.

27. A method comprising:
using a material comprising graphene in a lithium ion battery as a gas barrier for volatile components.

28. The method according to claim 27, wherein volatile component is selected from the group consisting of hydrogen fluoride and 1,3-propanesultone.
